(19) United States
(12) Patent Application Publication
(10) Pub. No.: US 2005/0081015 A1
(43) Pub. Date: Apr. 14, 2005

(54) Method and apparatus for adapting write instructions for an expansion bus

(76) Inventor: Peter J. Barry, Ardnacrusha (IE)

Correspondence Address: Schwegman, Lundberg, Woessner & Kluth, P.A., P.O. Box 2938, Minneapolis, MN, 55402, US

(21) Appl. No.: 10/677,082

(22) Filed: Sep. 30, 2003

(51) Int. Cl. G06F 15/00

(52) U.S. Cl. 712/1

(57) ABSTRACT

A method and apparatus for adapting write instructions for an expansion bus are described herein. In one embodiment, the method includes commencing execution of a first set of one or more write instructions, wherein the write instructions of the first set are the width of a processor data bus. The method also includes aborting the execution of the first set of write instructions. In response to the aborting, the method includes creating a second set of one or more write instructions, wherein the write instructions of the second set are the width of an expansion bus and executing the second set of write instructions. In one embodiment, the apparatus includes a memory management unit to receive a virtual address and determine whether the virtual address maps to an inaccessible physical address. The memory management unit is to transmit an abort indication if the virtual address maps to an inaccessible address. The apparatus also includes a processor core to receive the abort indication from the memory management unit and to execute instructions. In the apparatus, the processor core includes an abort handler to create new instructions in response to receipt of the abort indication, wherein the new instructions are the width of an expansion bus.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### FIELD

This invention relates generally to the field of processor write operations, and more specifically to the field of adapting processor write operations for an expansion bus.

### BACKGROUND

General-purpose computer architectures, consisting of one or more central processing units (CPU), typically include a system bus for connecting components within the CPU. For example, a system bus can be used for connecting one or more processor cores to a cache memory, memory management unit, and other various processor components. The processor components typically communicate with devices external to the CPU over an expansion bus. If the expansion bus width differs from the system bus width, communications (e.g., memory accesses) between processor components and external devices typically must be reformatted to account for the difference in the bus widths. In some prior art systems, hardware in the expansion bus controller reformats a limited number of the communications (e.g., only read operations) between processor components and external components. One disadvantage of the prior art systems is that they do not include functionality for reformatting all communications between processor components and external devices. As such, the prior art systems cannot execute legacy code that includes memory accesses not formatted for narrow expansion buses.

### BRIEF DESCRIPTION OF THE FIGURES

The present invention is illustrated by way of example and not limitation in the Figures of the accompanying drawings, in which like references indicate similar elements and in which:

FIG. 1 illustrates an exemplary computer system used in conjunction with certain embodiments of the invention;

FIG. 2 is a block diagram illustrating a processor connected to an external expansion device, according to exemplary embodiments of the invention;

FIG. 3 is a flow diagram illustrating operations for the adapting write instructions created for a processor data bus into write instructions for an expansion data bus, according to exemplary embodiments of the invention;

FIG. 4 is a flow diagram illustrating operations for executing a write instruction that writes to an external expansion device, according to exemplary embodiments of the invention;

FIG. 5 is a flow diagram illustrating operations performed by a memory management unit during the execution of a write instruction that writes to an external expansion device, according to exemplary embodiments of the invention;

FIG. 6 is a program segment including assembly code used by an abort handler, according to exemplary embodiments of the invention;

FIG. 7 is a flow diagram illustrating operations for executing an abort handler, according to exemplary embodiments of the invention;

FIG. 8 is a program segment including C code used by an abort handler, according to exemplary embodiments of the invention; and

FIG. 9 is a flow diagram illustrating operations for converting an instruction into multiple instructions suitable for transmission over an expansion bus, according to exemplary embodiments of the invention.

### DESCRIPTION OF THE EMBODIMENTS

In the following description, numerous specific details are set forth. However, it is understood that embodiments of the invention may be practiced without these specific details. In other instances, well-known circuits, structures and techniques have not been shown in detail in order not to obscure the understanding of this description.

Herein, block diagrams illustrate exemplary embodiments of the invention. Also herein, flow diagrams illustrate operations of the exemplary embodiments of the invention. The operations of the flow diagrams will be described with reference to the exemplary embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams.

This description of the embodiments is divided into three sections. In the first section, an exemplary hardware and operating environment is described. In the second section, a system overview is presented. In the third section, an exemplary implementation is described.

Hardware and Operating Environment

This section provides an overview of the exemplary hardware and the operating environment in which embodiments of the invention can be practiced.

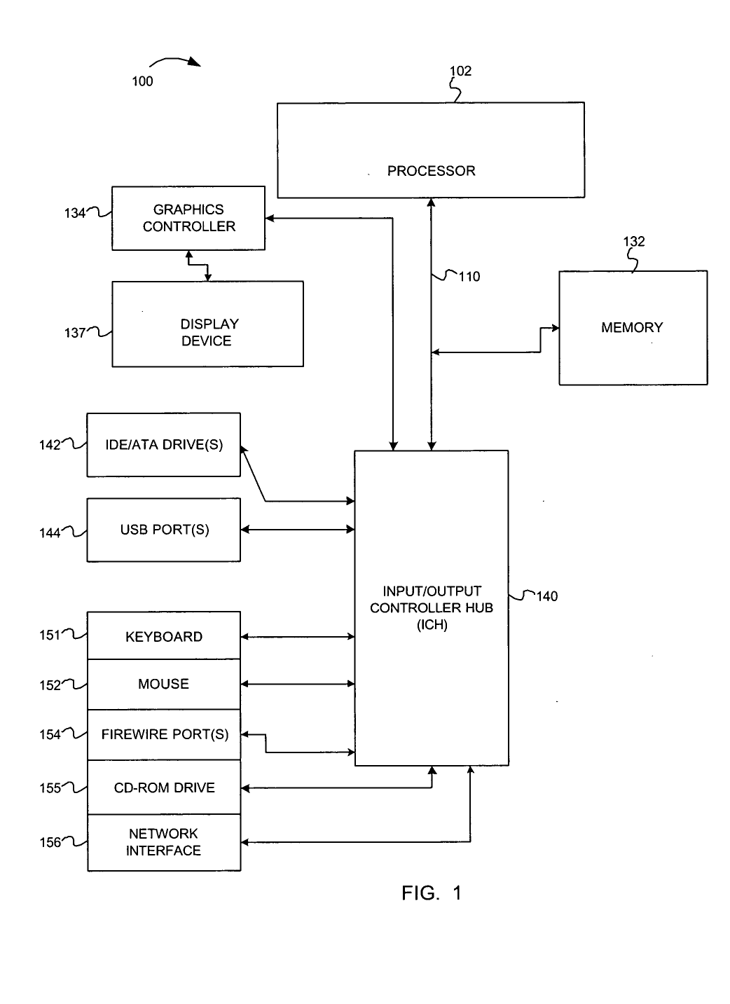

FIG. 1 illustrates an exemplary computer system used in conjunction with certain embodiments of the invention. As illustrated in FIG. 1, computer system 100 comprises processor 102. Computer system 100 also includes a memory 132, processor bus 110, and input/output controller hub (ICH) 140. The processor 102, memory 132, and ICH 140 are coupled to the processor bus 110. The processor 102 may comprise any suitable processor architecture. According to embodiments of the invention, the computer system 100 may comprise one, two, three, or more processors, any of which may execute a set of instructions in accordance with embodiments of the present invention.

The memory 132 stores data and/or instructions, and may comprise any suitable memory, such as a dynamic random access memory (DRAM), for example. The computer system 100 also includes IDE drive(s) 142 and/or other suitable storage devices. A graphics controller 134 controls the display of information on a display device 137, according to embodiments of the invention.

The input/output controller hub (ICH) 140 provides an interface to I/O devices or peripheral components for the computer system 100. The ICH 140 may comprise any suitable interface controller to provide for any suitable communication link to the processor 102, memory 132 and/or to any suitable device or component in communication with the ICH 140. For one embodiment of the invention, the ICH 140 provides suitable arbitration and buffering for each interface.

For one embodiment of the invention, the ICH 140 provides an interface to one or more suitable integrated drive electronics (IDE) drives 142, such as a hard disk drive (HDD) or compact disc read only memory (CD ROM) drive, or to suitable universal serial bus (USB) devices through one or more USB ports 144. For one embodiment, the ICH 140 also provides an interface to a keyboard 151, a mouse 152, a CD-ROM drive 155, one or more suitable devices through one or more parallel ports 153 (e.g., a printer), and one or more suitable devices through one or more firewire ports 154. For one embodiment of the invention, the ICH 140 also provides a network interface 156 though which the computer system 100 can communicate with other computers and/or devices.

In one embodiment, the computer system 100 includes a machine-readable medium that stores a set of instructions (e.g., software) embodying any one, or all, of the methodologies described herein. Furthermore, software can reside, completely or at least partially, within memory 132 and/or within the processor 102.

System Overview

In this section, a system overview is presented. The system overview presents a processor system architecture used in conjunction with embodiments of the invention. The system overview also presents the general functionality of the processor system architecture.

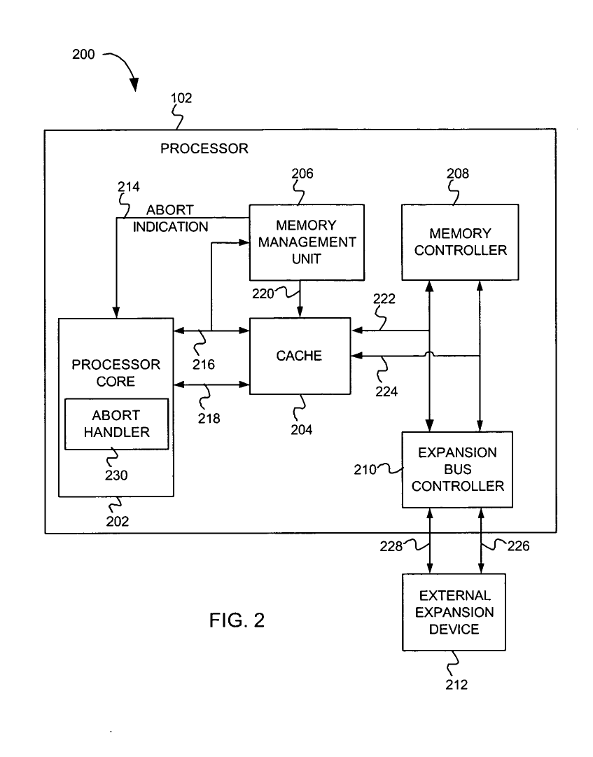

FIG. 2 is a block diagram illustrating a processor connected to an external expansion device, according to exemplary embodiments of the invention. As shown in FIG. 2, the processor system 200 includes the processor 102, which includes a number of interconnected functional units (e.g., processor core 202, cache 204, etc.). In FIG. 2, a processor core 202 is connected to a cache 204 by a processor address bus 216 and a processor data bus 218. The processor address bus 216 transmits both address and control data between the processor's functional units. The processor core 202 includes an abort handler 230. The processor core 202 is also connected to a memory management unit 206 by a communication bus 214 and the processor address bus 216. The memory management unit (MMU) 206 can send an abort indication (described in greater detail below) to the processor core 202 over the communication bus 214. In one embodiment, the processor has a precise abort mechanism. That is, the abort handler 230 can determine the address of the write instruction being aborted. In one embodiment, the abort handler 230 calculates the address of the aborted write instruction by subtracting a value (e.g., 8) from a program counter maintained within the processor core 202.

In one embodiment, the MMU 206 stores translations tables (e.g., page tables) for translating virtual addresses into physical address. In one embodiment, the translation table entries include fields for write protecting memory locations and for managing cache entries (e.g., clean fields, dirty fields, reuse fields, etc.). In one embodiment, each virtual address that maps to the external expansion device is write-protected. That is, the write-protect field for each translation table entry corresponding to a physical address in the external expansion device's address space is marked to indicate that the address is write-protected. Alternative embodiments, call for similar translation table fields for indicating that the virtual address maps to an external expansion device. When the MMU 206 attempts to resolve virtual addresses that are write-protected, the MMU 206 transmits an abort signal to the processor core 202, as described in greater detail below (see the next section).

The cache 204 is connected to a memory controller 208 and an expansion bus controller 210 via a processor address bus 222 and a processor data bus 224. In one embodiment, the processor address bus 222 transmits address and control information between the processor's functional units. The expansion bus controller 210 is connected to an external expansion device 212 by an expansion address bus 228 and an expansion data bus 226. In one embodiment the expansion bus is 16 bits wide, while in other embodiments it has other suitable widths. In one embodiment, the expansion bus controller 210 is connected to six external expansion devices (not shown). According to alternative embodiments, the expansion bus controller 210 is connected to a greater or lesser number of external expansion devices 212. In one embodiment, the expansion device 212 is a flash memory drive. In alternative embodiments, the expansion device 212 is any other suitable device coupled to the processor.

In one embodiment, the width of the processor address buses is 32-bits, while the expansion data bus 226 is 16 bits wide. In one embodiment, hardware in the expansion bus controller 210 can combine two read instructions, received over the 16-bit expansion data bus 226, into a single read instruction suited for transmission over the 32-bit processor address bus.

It should be understood that the various functional units of the processor 102 could be interconnected according to any suitable architecture (e.g., the functional units could be fully connected). As noted above, in some embodiments, the processor data buses can be 32-bits wide, while in other embodiments they can be any suitable width (e.g., 64 bits, 128 bits, etc.). In one embodiment, although not shown in FIG. 2, the data buses are connected, making-up a single processor data bus. It should also be understood that the some of the processor's functional units could be further integrated and/or subdivided, while still performing the functionality described herein.

Any of the functional units used in conjunction with embodiments of the invention can include machine-readable media for performing operations described herein. Machine-readable media includes any mechanism that provides (i.e., stores and/or transmits) information in a form readable by a machine (e.g., a computer). For example, a machine-readable medium includes read only memory (ROM), random access memory (RAM), magnetic disk storage media, optical storage media, flash memory devices, electrical, optical, acoustical or other forms of propagated signals (e.g., carrier waves, infrared signals, digital signals, etc.), etc. According to embodiments of the invention, the functional units, including the abort handler 230, can be other types of logic (e.g., digital logic) for executing the operations described herein.

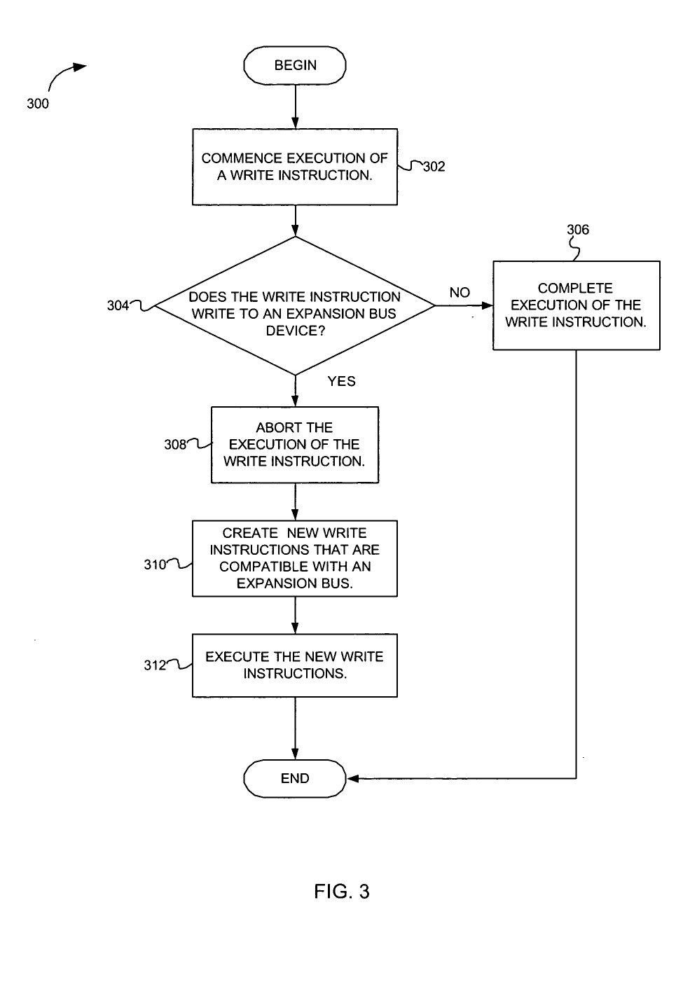

FIG. 3 is a flow diagram illustrating operations for the adapting write instructions created for a processor data bus into write instructions for an expansion data bus, according to exemplary embodiments of the invention. The flow diagram 300 of FIG. 3 will be described with reference to the exemplary processor system of FIG. 2. The flow diagram 300 begins at block 302, wherein execution of a write instruction commences. For example, the processor system 200 commences execution of a write instruction. The flow continues at block 304.

At block 304, it is determined whether the write instruction writes to an external expansion device. For example, the processor system 200 determines whether the write instruction is writing to the external expansion device 212. If the processor system 200 is writing to the external expansion device 212, the flow continues at block 308. Otherwise, the flow continues at block 306.

As shown in block 306, execution of the write instruction is completed. For example, the processor system 200 completes the write instruction. From block 306, the flow ends.

At block 308, execution of the write instruction is aborted. For example, the processor system 200 aborts execution of the write instruction. The flow continues at block 310.

As shown in block 310, new write instructions compatible with the expansion bus are created. For example, the processor system 200 creates new instructions that are suited for transmission across the expansion data bus 226. The flow continues at block 312.

At block 312, the newly created write instructions are executed. For example, the processor system 200 executes the newly created write instructions. From block 312, the flow ends.

While the discussion of FIG. 3 describes general operations for adapting write instructions for an expansion bus, the next sections more specifically describe operations of the processor core 202, memory management unit 206, and abort handler 230.

Exemplary Implementation

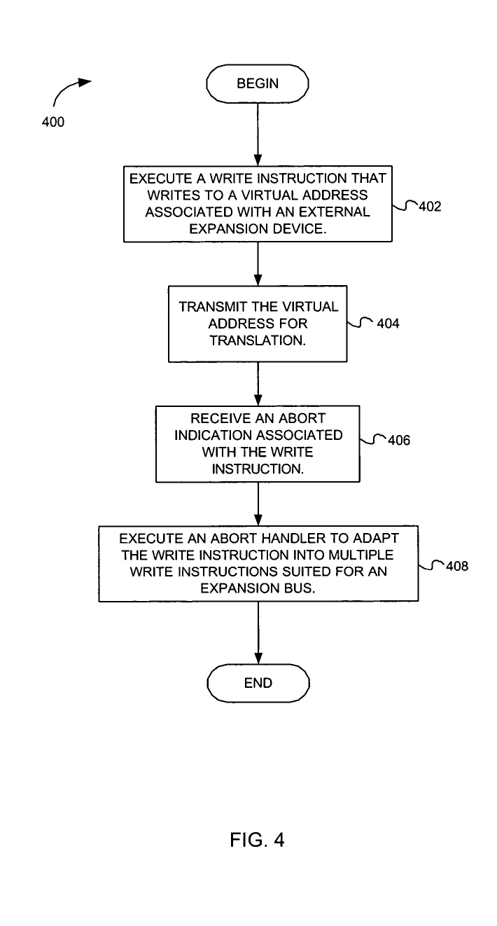

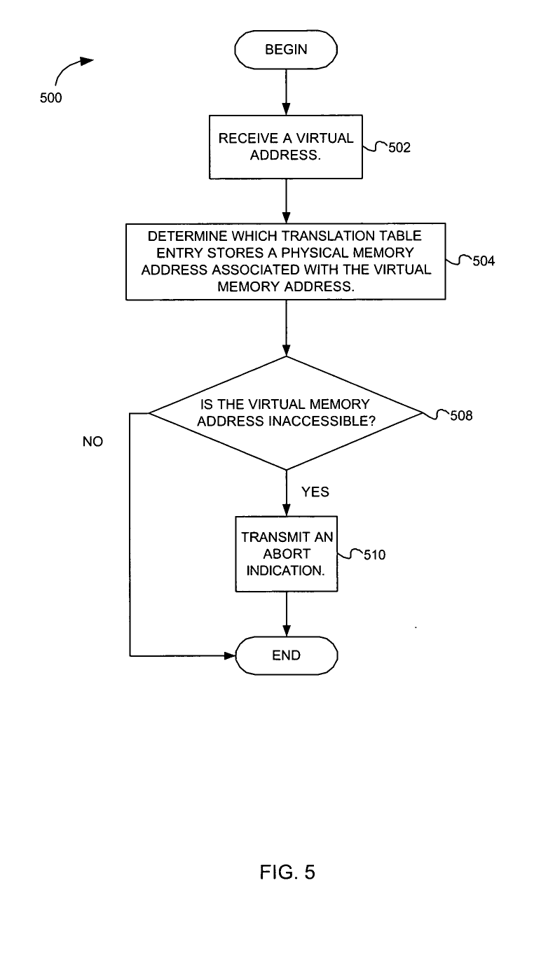

This section provides an exemplary implementation of embodiments of the invention. In this section, FIG. 4 describes operations performed by the processor core, while FIG. 5 describes operations performed by the memory management unit. The operations of FIGS. 4 and 5 describe operations for executing and creating instructions for writing to an external expansion device.

FIG. 4 is a flow diagram illustrating operations performed by a processor core for executing a write instruction that writes to an external expansion device, according to exemplary embodiments of the invention. The flow diagram 400 will be described with reference to the exemplary processor system of FIG. 2. The flow diagram 400 commences at block 402, wherein a write instruction that writes to a virtual address associated with an external expansion device is executed. For example, the processor core 202 executes a write instruction that writes to a virtual address associated with the external expansion device 212. The flow continues at block 404.

At block 404, the virtual address is transmitted for translation. For example, the processor core 202 transmits the virtual address to the memory management unit 206 for translation into a physical address associated with the external expansion device 212. The flow continues at block 406.

As shown in block 406, an abort indication associated with the write instruction is received. For example, the processor core 202 receives an abort indication from the MMU 206. The flow continues at block 408.

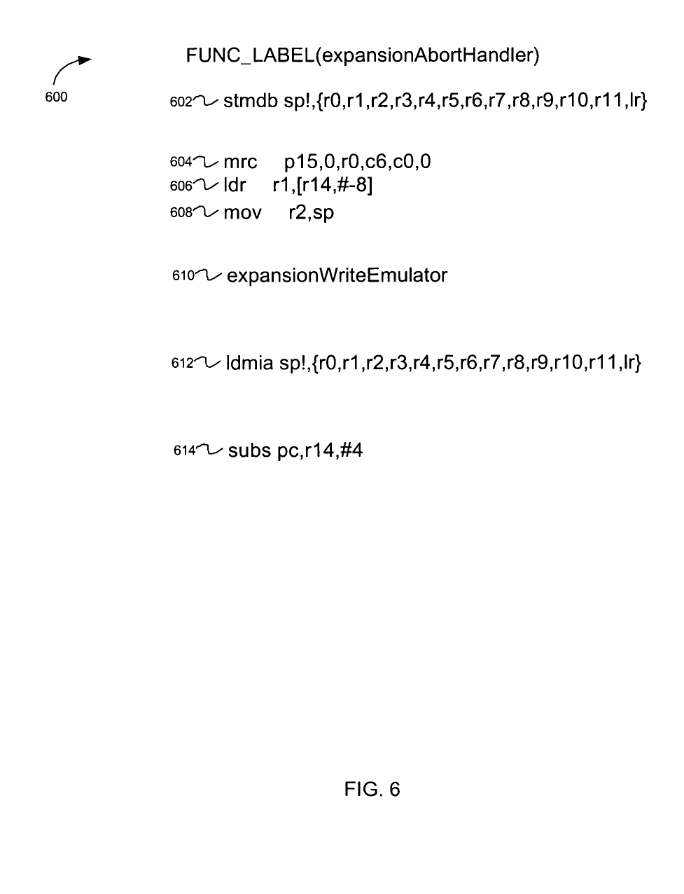

At block 408, an abort handler is executed to adapt the write instruction into multiple write instructions suited for an expansion bus. For example, the processor core 202 executes the abort handler 230 to adapt the write instruction into multiple write instructions suited for transmission over the expansion data bus 226. In one embodiment, for each 32-bit write instruction, the abort handler produces two 16-bit write instructions suitable for transmission over the expansion data bus 226. In one embodiment, for each 8-bit or 16-bit write instruction, the abort handler 230 generates an 8-bit or 16-bit write instruction suitable for transmission over the expansion data bus 226. In an alternative embodiment, the abort handler 230 does not create new write instructions when the original write instruction is not wider than the expansion data bus 226. Exemplary operations and program code for implementing an abort handler are described in greater detail below, with reference to FIGS. 6-9. From block 408, the flow ends.

FIG. 5 is a flow diagram illustrating operations performed by a memory management unit during the execution of a write instruction that writes to an external expansion device, according to exemplary embodiments of the invention. The flow diagram 500 will be described with reference to the exemplary processor system of FIG. 2. The flow diagram 500 commences at block 502, wherein a virtual address is received. For example, the memory management unit 206 receives a virtual address from the processor core 202 over the processor address bus 216. The flow continues at block 504.

As shown in block 504, it is determined which translation table entry stores a physical memory address associated with the virtual memory address. For example, the MMU 206 determines which of its translation table entries stores the physical memory address associated with the virtual memory address. In one embodiment, the MMU 206 finds the corresponding physical address by using the virtual address as an index into a page table. The flow continues at block 508.

At block 508, it is determined whether the virtual memory address is inaccessible. For example, the MMU 206 inspects the translation table entry to determine whether the virtual memory address is inaccessible. In one embodiment, a virtual memory address is inaccessible if it is not mapped to a physical memory address. Alternatively, in one embodiment, the virtual memory address is inaccessible if the virtual memory address is “write protected.” In one embodiment, the MMU 206 inspects a write-protected field of a page table entry to determine whether the virtual memory address is write-protected. If the virtual memory address is inaccessible, the flow continues at block 510. Otherwise, the flow ends.

At block 510, an abort indication is transmitted. For example, the MMU 206 transmits an abort indication to the processor core 202 over the communication bus 214. In one embodiment, the abort indication is a data packet including information about the address of the instruction that is attempting to access a write-protected memory location and the physical address associated with the virtual address. According to alternative embodiments, the abort indication can be a signal or other suitable intra-processor communication. From block 510, the flow ends.

In the discussion above, FIGS. 4 and 5 described operations performed for transmitting and receiving an abort indication. In the discussion below, FIGS. 6-10 will describe code and operations of an abort handler that creates adapted write instructions in response to the abort indication.

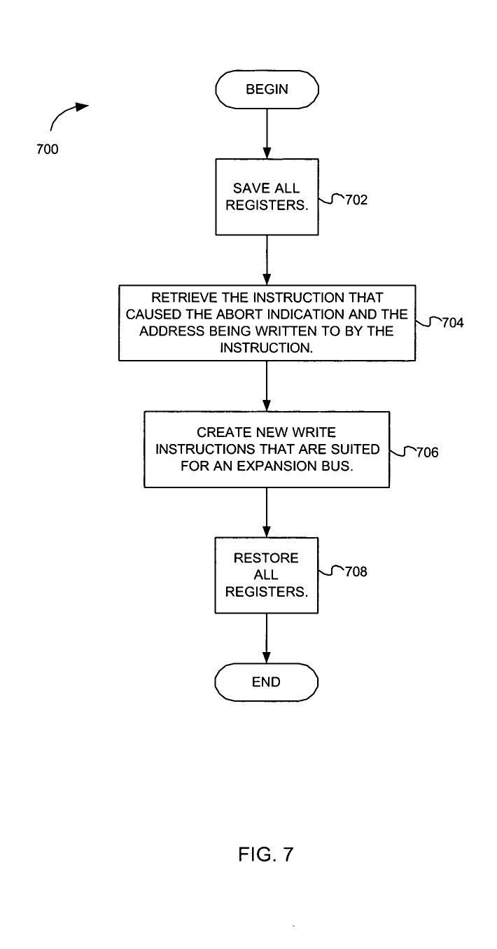

FIG. 6 is a program segment including XSCALE assembly code used by an abort handler, according to exemplary embodiments of the invention. As shown in FIG. 6, the code segment 600 includes instructions 602, 604, 606, 608, 610, 612, and 614. The code segment 600 will be described in more detail below, with reference to FIG. 7.

FIG. 7 is a flow diagram illustrating operations for executing an abort handler, according to exemplary embodiments of the invention. The flow diagram 700 will be described with reference to the exemplary processor system of FIG. 2 and the code segment of FIG. 7. The flow diagram 700 commences at block 702, wherein all the registers are saved. For example, the abort handler 230 (see FIG. 2) saves all the register values to a stack (not shown) disposed within the processor 102. Referring to the code segment of FIG. 6, instruction 602 stores the register values on a stack. The flow continues at block 704.

At block 704, the instruction that caused the abort indication is fetched along with the address being written to by the instruction. For example, the abort handler 230 fetches the instruction that caused the abort indication along with the address being written to by the instruction. Referring to the code segment of FIG. 6, instructions 604, 606, and 608 are instructions for fetching the instruction and the address being written to by the instruction. The flow continues at block 706.

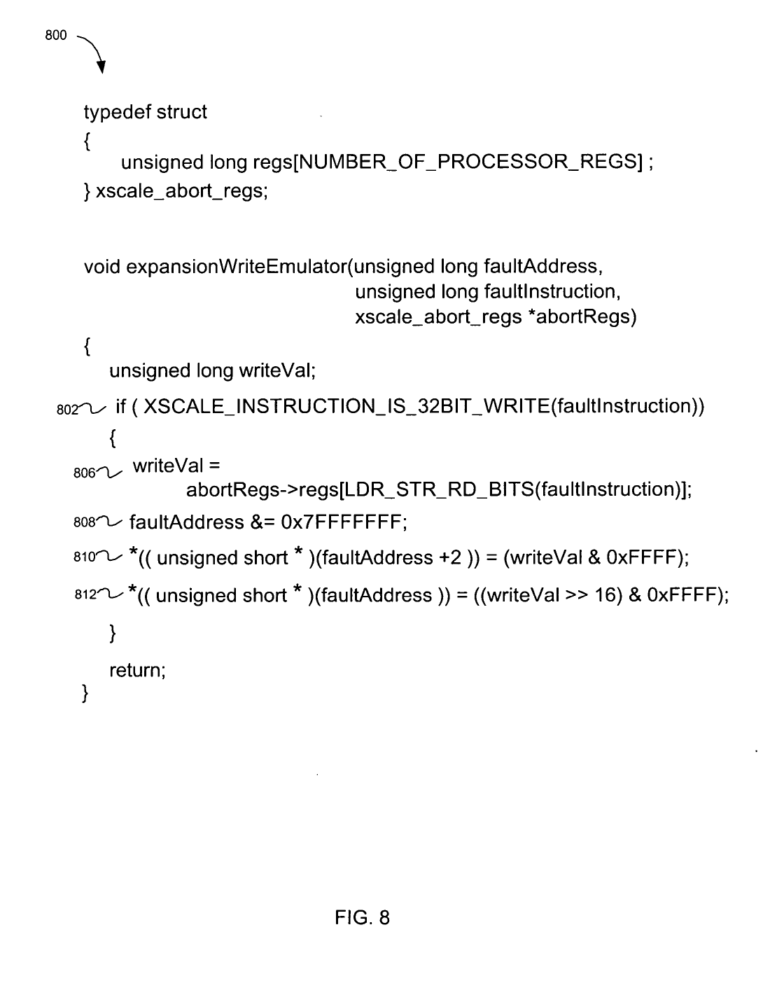

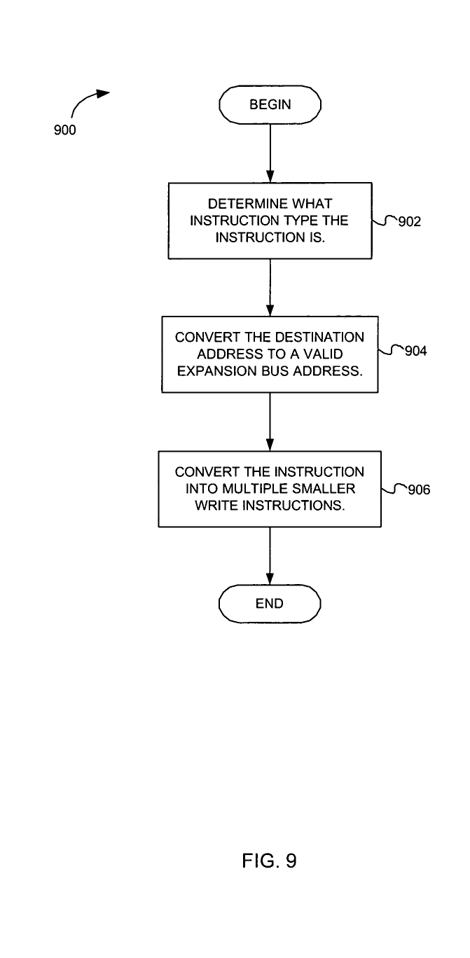

As shown in block 706, new write instructions that are suited for an expansion bus are created. For example, the abort handler 230 creates new write instructions that are suited for the expansion data bus 226. In one embodiment, the abort handler 230 calls a subroutine to create two 16-bit write instructions for each 32-bit write instruction. For example, referring to the code segment of FIG. 6, instruction 610 calls a subroutine that creates two 16-bit write instructions for each 32-bit write instruction. Alternative embodiments that call for different bus widths also call for creating differently sized write instructions. Operations and program code for creating new instructions are described below, with reference to FIGS. 8 and 9. The flow continues at block 708.

At block 708, the registers are restored. For example, the abort handler 230 restores the register values. In one embodiment, the abort handler 230 pops the stored register values off the stack and assigns them to the registers (see instruction 612 of FIG. 6). From block 708, the flow ends.

FIG. 8 is a program segment including C code used by an abort handler, according to exemplary embodiments of the invention. As shown in FIG. 8, the code segment 800 includes instructions 802, 804, 806, 808. The code segment 800 will be described in more detail below, with reference to FIG. 9.

FIG. 9 is a flow diagram illustrating operations for converting an instruction into multiple instructions suitable for transmission over an expansion bus, according to exemplary embodiments of the invention. The flow diagram 900 will be described with reference to the exemplary processor system of FIG. 2 and the code segment of FIG. 8. The flow diagram 900 commences at block 902, wherein the instruction type is determined. For example, the abort handler 230 determines the instruction type of the instruction that caused the abort indication. Referring to FIG. 8, instruction 802 determines the instruction type. The flow continues at block 904.

At block 904, the destination address is converted to a valid expansion bus address. For example, the abort handler 230 converts the destination address received from the MMU 206 into a valid virtual address (i.e., a virtual address that will not cause the MMU 206 to transmit an abort indication) that maps to the physical address space of the external expansion device 212. Referring to FIG. 8, instruction 808 converts the destination address into a valid virtual address. The flow continues at block 906.

As shown in block 906, the instruction is converted into multiple smaller write instructions. For example, the abort handler 230 converts the instruction into multiple smaller write instructions. In one embodiment, two 16-bit write instructions are created for each 32-bit write instruction. Referring to FIG. 8, instructions 810 and 812 create multiple write instructions that are suitable for transmission over the expansion data bus 226. From block 906, the flow ends.

Thus, a method and apparatus for adapting write instructions for an expansion bus have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A method comprising:
commencing execution of a first set of one or more write instructions, wherein the write instructions of the first set are the width of a processor data bus;
aborting the execution of the first set of write instructions;
creating a second set of one or more write instructions, in response to the aborting, wherein the write instructions of the second set are the width of an expansion bus; and
executing the second set of write instructions.

2. The method of claim 1, wherein the width of the processor bus is 32 bits.

3. The method of claim 1, wherein the width of the expansion bus is 16 bits.

4. The method of claim 1, wherein the second set of write instructions are suitable for transmission over the expansion bus.

5. A method comprising:
executing a write instruction that writes to a virtual memory address;
translating the virtual memory address, wherein translating includes determining whether the virtual memory address maps to an inaccessible physical memory address;
generating an abort indication after determining that the virtual memory address maps to an inaccessible physical memory address;
performing the following in response to the abort indication, creating multiple write instructions suited for transmission over an expansion bus; and
executing the multiple write instructions.

6. The method of claim 5, wherein the expansion bus is 16 bit wide.

7. The method of claim 6, wherein the write instruction is a 32-bit write instruction.

8. The method of claim 6, wherein the write instruction is wider than the expansion bus.

9. An apparatus comprising:
a memory management unit to receive a virtual address, the memory management unit to determine whether the virtual address maps to an inaccessible physical address and to transmit an abort indication if the virtual address maps to an inaccessible address; and
a processor core to receive the abort indication from the memory management unit and to execute instructions, the processor core including an abort handler to create new instructions in response to receipt of the abort indication, wherein the new instructions are the width of an expansion bus.

10. The apparatus of claim 9, wherein a physical address is inaccessible if it is write-protected.

11. The apparatus of claim 9 further comprising:
an external expansion device communicatively coupled to the processor core, the external expansion device to receive the new instructions over the expansion bus.

12. The apparatus of claim 11, wherein the expansion bus is 16 bits wide.

13. The apparatus of claim 9, wherein instructions are 32-bit instructions.

14. A system comprising:
a processor, the processor including,
processor core to receive an abort indication, wherein the processor core includes an abort handler to create new write instructions suited for transmission over an expansion bus; and
a memory management unit (MMU) coupled to the processor core by a processor data bus, the MMU to determine whether a virtual memory address maps to an accessible physical memory address, the MMU to transmit the abort indication to the processor core if the virtual memory address does not map to an accessible physical memory address;
an external expansion device to receive the new write instructions from the processor over the expansion bus; and
a dynamic random access memory (DRAM) unit coupled to the processor, wherein the DRAM unit is to store data accessible by the processor.

15. The system of claim 14, wherein the expansion bus is half the width of the processor data bus.

16. The system of claim 14, wherein the abort indication includes the virtual memory address.

17. The system of claim 14, wherein the external expansion device is a flash memory device.

18. A machine-readable medium that provides instructions, which when executed by a machine, cause the machine to perform operations comprising:
commencing execution of a first set of one or more write instructions, wherein the write instructions of the first set are the width of a processor data bus;
aborting the execution of the first set of write instructions;
in response to the aborting, creating a second set of one or more write instructions, wherein the write instructions of the second set are the width of an expansion bus;
executing the second set of write instructions.

19. The machine-readable medium of claim 18, wherein the width of the processor bus is 32 bit.

20. The machine-readable medium of claim 18, wherein the width of the expansion bus is 16 bit.

21. The machine-readable medium of claim 18, wherein the second set of write instructions are suitable for transmission over the expansion bus.

22. A machine-readable medium that provides instructions, which when executed by a machine, cause the machine to perform operations comprising:
executing a write instruction that writes to a virtual memory address;
translating the virtual memory address, wherein translating includes determining whether the virtual memory address maps to an inaccessible physical memory address;
after determining whether the virtual memory address maps to an inaccessible physical memory address, generating an abort indication;
receiving the abort indication, and
creating multiple write instructions suited for transmission over an expansion bus; and
executing the multiple write instructions.

23. The machine-readable medium of claim 22, wherein the expansion bus is 16 bits wide.

24. The machine-readable medium of claim 22, wherein the write instruction is a 32-bit instruction.

25. The machine-readable medium of claim 22, wherein the write instruction is wider than the expansion bus.
